(19) United States
(12) Patent Application Publication
(10) Pub. No.: US 2023/0182675 A1
(43) Pub. Date: Jun. 15, 2023

(54) INFLATABLE CURTAIN AIRBAG WITH BI-ROLL PACKAGE STATE

(71) Applicant: Autoliv ASP, Inc., Ogden, UT (US)

(72) Inventors: Nicholas Crawford, Roy, UT (US); Stephen Blake Farley, Orem, UT (US); Blake Homer Garn, Millville, UT (US); Kevin Button, Plain City, UT (US)

(21) Appl. No.: 17/644,267

(22) Filed: Dec. 14, 2021

(51) Int. Cl. B60R 21/232; B60R 21/213; B60R 21/217

(52) U.S. Cl. CPC B60R 21/232; B60R 21/213; B60R 21/2176

(57) ABSTRACT

Inflatable curtain airbags and airbag assemblies that can provide for proper deployment. The inflatable curtain airbags can include one or more cushion segments. The inflatable curtain airbags can be rolled into a bi-roll for a packaged state. The bi-roll can include a lower portion of the inflatable curtain airbag rolled in a first rotational direction and an upper portion rolled in a second rotational direction, opposite of the first rotational direction. The inflatable curtain airbags can also include one or more attachment areas disposed at or adjacent an upper edge of the one or more cushion segments. Mounting tabs may be coupled to the attachment areas and the mounting tabs may be used for installation of the inflatable curtain airbag in a vehicle.

### TECHNICAL FIELD

The present disclosure relates generally to the field of automotive protective systems. More specifically, the present disclosure relates to inflatable airbag cushion assemblies in a packaged state.

### BRIEF DESCRIPTION OF THE DRAWINGS

The written disclosure herein describes illustrative embodiments that are non-limiting and non-exhaustive. Reference is made to certain of such illustrative embodiments that are depicted in the figures, in which:

FIG. 1 is a side view of an interior of a vehicle with an inflatable curtain airbag in an undeployed state according to one embodiment of the present disclosure.

FIG. 2 is a perspective view of an airbag cushion of the inflatable curtain airbag of FIG. 1 shown prior to installation and packaging.

FIG. 3A is a perspective view of the airbag cushion of FIG. 2 in a first partially packaged state, according to one embodiment of the present disclosure.

FIG. 3B is a cross-sectional view of the airbag cushion of FIG. 3A in the first partially packaged state.

FIG. 4A is a perspective view of the airbag cushion of FIG. 2 in a second partially packaged state, according to one embodiment of the present disclosure.

FIG. 4B is a cross-sectional view of the airbag cushion of FIG. 4A in the second partially packaged state.

FIG. 5A is a perspective view of the airbag cushion of FIG. 2 in a packaged state, according to one embodiment of the present disclosure.

FIG. 5B is a cross-sectional view of the airbag cushion of FIG. 5 in the packaged state.

### DESCRIPTION

It will be readily understood that the components of the embodiments as generally described and illustrated in the figures herein could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The phrase “coupled to” is used in its ordinary sense and is broad enough to refer to any suitable coupling or other form of interaction between two or more entities, including mechanical, fluid, and thermal interaction. Two components may be coupled to each other even though they are not in direct contact with each other.

The phrase “attached to” refers to interaction between two or more entities that are in direct contact with each other and/or are separated from each other only by a fastener of any suitable variety (e.g., mounting hardware or an adhesive).

The phrase “fluid communication” is used in its ordinary sense and is broad enough to refer to arrangements in which a fluid (e.g., a gas or a liquid) can flow from one element to another element when the elements are in fluid communication with each other.

The terms “longitudinal” and “longitudinally” refer to a direction or orientation extending or spanning between a front of a vehicle and a rear of the vehicle.

Inflatable airbag systems are widely used to reduce or minimize occupant injury in a collision scenario. Airbag modules have been installed at various locations within a vehicle, including, but not limited to, the steering wheel, the instrument panel, within the side doors or side seats, adjacent to the roof rail of the vehicle, in an overhead position, or at the knee or leg position. In the following disclosure, “airbag” generally refers to an inflatable curtain airbag or cushion, although the principles discussed may apply to other airbag types in other embodiments.

Inflatable curtain airbags typically extend longitudinally within the vehicle and are usually coupled to or adjacent a roof rail of the vehicle and, when inflated, extend along the side of the vehicle between the occupant and the side panels and/or windows of the vehicle to protect an occupant (and in particular, an occupant's head) during a collision event. In an undeployed state, inflatable curtain cushions are typically rolled and/or folded and may be retained in the undeployed configuration by being wrapped in a restraint at various attachment points at which the inflatable airbag is attached to the vehicle, or by being enclosed in a restraint, such as a sleeve or sock. The undeployed state may also be referred to as a “packaged state.” In transitioning to a deployed state, an inflatable curtain cushion may receive inflation gas from an inflator and expand and burst free from the restraint to cover at least a portion of the side windows and one or more pillars of the vehicle. In some embodiments, inflatable curtain cushions may cover one or more of the A, B, C, and D pillars of a vehicle. For example, in some embodiments, a deployed inflatable curtain airbag may extend from the A pillar to the C pillar of the vehicle. In other embodiments, a deployed inflatable curtain airbag may extend from the A pillar to the D pillar of the vehicle.

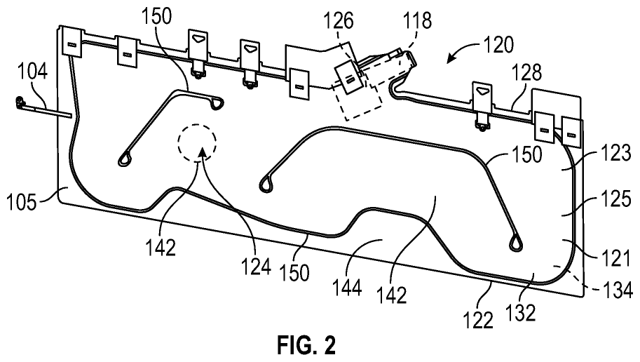

Some inflatable curtain airbags may be configured to serve dual functions of cushioning and ejection prevention. During a collision event, an inflatable curtain airbag may cushion the head and upper body of an occupant. The area(s) where the occupant is likely to contact the inflatable curtain airbag during a collision may be referred to as the “occupant receiving area(s)” (see, e.g., FIG. 2). During a rollover event, the inflatable curtain airbag may function to help retain the occupant within the vehicle. Inflatable curtain airbags can reduce or mitigate the risk of occupant ejection by forming a barrier between the occupant and the side windows.

Inflatable curtain airbags often include an inflatable cushion or cushion segment comprising one or more panels, such as fabric panels. In some embodiments, inflatable cushions can include two fabric panels that are coupled or bonded together by, for example, stitching, adhesives, or radiofrequency welding. In some other embodiments, inflatable cushions can include a single fabric body or panel, woven via a one-piece weaving technique to form one or more inflatable chambers.

Some embodiments disclosed herein can provide dynamic deployment of the curtain airbag to better protect a vehicle occupant during a collision or rollover and to meet industry airbag standards, such as those pertaining to the Head On Glass (HOG) test and Out-of-Position (OOP) situations. The HOG test is designed to test a propensity or ability of an airbag to help prevent an occupant's head from contacting glass of the vehicle, such as the front windshield, the rear windshield, and the windows during a collision or rollover event. Curtain airbags are designed to deploy from the roof of the vehicle and be disposed between the occupant (e.g., head and body) and the windows of the vehicle on either the driver's side of the vehicle or the passenger side of the vehicle. In addition, curtain airbags can be designed to provide rollover protection to the occupant in case of a vehicle rollover. For example, the curtain airbag can be configured to cover the window when deployed to prevent the occupant from being ejected through the window. Further, the curtain airbag may stay inflated for a predetermined amount of time after deployment so that the curtain airbag continues to cover the window and prevent the occupant from being ejected through the window.

OOP situations are situations in which the occupant is out of position relative to a standard occupant position or position for which the vehicle and/or seating positioned are configured accommodate an occupant (e.g., an occupant who is in a seat belted position). Example OOP situations include: the occupant is reclined, sitting sideways, bending forward, legs crossed, feet on the dashboard, arm out of the window, knees to the chest, etc. The curtain airbag can be configured to help protect the occupant in some of these OOP situations.

Certain embodiments disclosed herein are described as curtain airbags in a packaged state where the curtain airbag is rolled into a bi-roll configuration. For example, the bi-roll is formed by the inflatable cushion being rolled from a first side of the cushion toward a second side of the cushion in a first rotational direction and then continuing to be rolled toward the second side in a second rotational direction that is opposite the first. Another example includes the bi-roll comprising a first portion rolled in a first rotational direction and a second portion rolled in a second rotational direction. Another example includes the bi-roll comprising a first portion rolled in a direction in a first rotational direction about a roll axis and a second portion rolled in the direction about the roll axis in a second rotational direction, which is opposite the first rotational direction. Another example includes the bi-roll comprising a first longitudinal roll of a lower portion of the inflatable curtain airbag in a first rotational direction and a second longitudinal roll of an upper portion of the inflatable curtain airbag in a second rotational direction. Another example includes a roll configuration that comprises an inboard longitudinal roll of a lower portion of the curtain airbag and an outboard longitudinal roll of an upper portion of the curtain airbag. When deployed, the upper portion can be positioned between the occupant's head and the lower portion can maintain the curtain airbag inside the door trim of the vehicle.

As used herein, inboard refers to a direction toward a centerline of a vehicle and outboard refers to a direction out of the vehicle and away from a centerline of the vehicle.

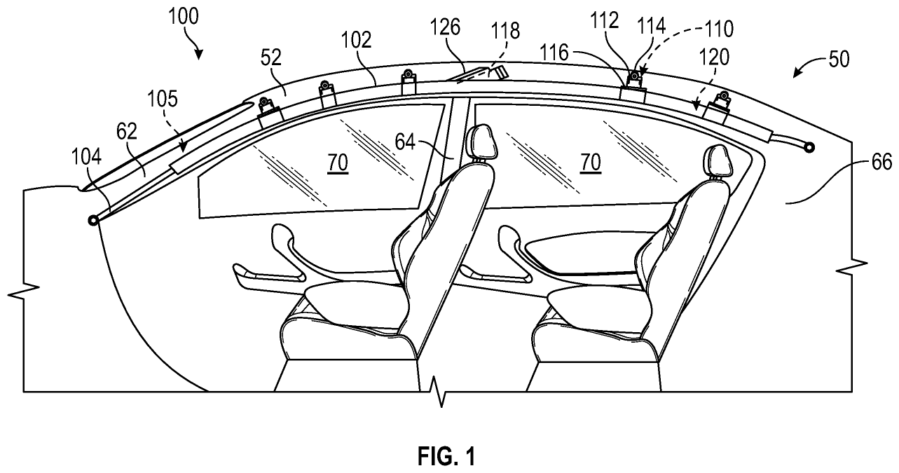

FIG. 1 depicts an inflatable curtain airbag 100 installed in a vehicle 50 on a passenger side of the vehicle 50 that extends along a longitudinal length of the vehicle 50. The inflatable curtain airbag 100 may also be installed in a driver side of the vehicle 50. The inflatable curtain airbag 100 includes an airbag cushion 120 that is positioned at an interior of a restraint 102 so as to be retained in a packaged state. The restraint 102 may be of any suitable variety, such as one or more straps, tethers, socks, or sleeves. In the illustrated embodiment, the restraint 102 includes a sleeve that holds the airbag cushion 120 in a bi-roll or pre-deployment configuration.

The inflatable curtain airbag 100 can be attached to the vehicle 50 in any suitable manner. For example, in some embodiments, the inflatable curtain airbag 100 includes one or more fastening assemblies 110 that are configured to secure one or more of the airbag cushion 120 and the restraint 102 to the vehicle 50. The inflatable curtain airbag 100 can be mounted inside the vehicle 50 adjacent to a roof of the vehicle, such as to a roof rail 52, and above one or more windows 70. In the illustrated embodiment, each fastening assembly 110 includes a mounting tab 116 (also referred to as a mounting strap or mounting tether) that is secured to mounting hardware, such as a mounting bracket 112 that is to be secured to the roof rail 52 via a fastener 114, such as a bolt or clip. Any other suitable fastening arrangement is also contemplated. Each mounting tab 116 may be coupled with one or more of the airbag cushion 120 and the restraint 102 in any suitable manner.

A forward end or portion 105 of the inflatable curtain airbag 100 can include a strap 104, which may be secured to the vehicle 50 in any suitable manner. For example, in the illustrated embodiment, the strap 104 is attached to a lower end of an A pillar 62. As shown in FIG. 2, the strap 104 can be attached to the forward end 105 of the airbag cushion 120.

With continued reference to FIG. 1, the inflatable curtain airbag 100 can further include an inflator 118, which may be positioned within a throat 126 of the airbag cushion 120. The inflator 118 can be anchored to the roof rail 52 and may be of any suitable variety. In some embodiments, the inflator 118 includes either a pyrotechnic device or a stored gas inflator. The inflator 118 can be in electronic communication with vehicle sensors that are configured to detect vehicle collisions and/or rollovers. Upon detection of predetermined conditions, the sensors can activate the inflator 118 to expel inflation gas and the airbag cushion 120 may be rapidly inflated.

When deployed, the airbag cushion 120 is configured to cover various structures of the vehicle 50. For example, in some embodiments, at least a portion of the deployed airbag cushion 120 can cover one or more of the A pillar 62, a B pillar 64, and a C pillar 66, and/or one or more side windows 70. The illustrated embodiment is configured to cover the B pillar 64 and each of the windows 70.

FIG. 2 illustrates the airbag cushion 120 in a pre-packaged configuration, for example, prior to packaging and/or installing the airbag cushion 120 in a vehicle. As discussed above, the airbag cushion 120 of the inflatable curtain airbag 100 may be installed on either the driver's side or the passenger side of the vehicle. The airbag cushion 120 can include a lower edge 122, an upper edge 128, a lower portion 121, an upper portion 123, and a middle portion 125. The middle portion 125 is disposed between the lower portion 121 and the upper portion 123. In some embodiments, the middle portion 125 is at a vertical midpoint between the lower edge 122 and the upper edge 128. The airbag cushion 120 can include various inflatable chambers configured to receive, direct, and/or retain inflation gas from the inflator 118. Some of the inflatable chambers are cushion segments 142 that are configured to be filled with inflation gases to cushion a vehicle occupant during a collision event. The cushion segments 142 can be configured to inflate at strategic areas at which a vehicle occupant may benefit most from the cushioning, such as occupant receiving area(s) 124. In the illustrated embodiment, the cushion segments 142 are in fluid communication with the throat 126 of the airbag cushion 120. In some embodiments, inflation gases may be retained within a given cushion segment 142 to maintain the cushion segment 142 in an inflated or filled configuration, even when a vehicle occupant presses against the cushion segment 142. Such an arrangement can allow the cushion segment 142 to provide a desired amount of protection to the vehicle occupant. In some embodiments, the one or more cushion segments 142 may be formed from one or more panels, wherein the one or more panels may comprise fabric or another suitable material. In certain embodiments, the upper edge 128 of the cushion segment 142 may comprise a selvage area of the fabric (e.g., an edge area or portion configured to prevent unraveling of the fabric).

In some embodiments, the airbag cushion 120 can include one or more non-inflatable regions 144. One or more of the non-inflatable regions 144 may be positioned between adjacent cushion segments 142 or at an interior of a cushion segment 142 (e.g., so as to be encompassed by a cushion segment 142).

In various embodiments, at least a portion of one or more of the cushion segments 142 and the non-inflatable regions 144 can be defined by one or more boundary seams 150. The one or more boundary seams 150 may be formed in any suitable manner. For example, in some embodiments, the one or more boundary seams 150 may include one or more of stitches, welds (e.g., radiofrequency welds), and/or adhesives. In other or further embodiments, the boundary seams 150 may be woven portions that are formed via one-piece weaving techniques. In some embodiments, the boundary seams 150 may join together two or more pieces of fabric, such as an inboard face or panel 132 and an outboard face or panel 134. In some embodiments, the one or more boundary seams 150 are substantially airtight so as to be able to retain inflation gas within a given cushion segment 142. The one or more boundary seams 150 can be said to fluidly isolate adjacent cushion segments 142 from each other. In other embodiments, the one or more boundary seams 150 may not be airtight, but may instead resist egress of gases from the cushion segment 142.

The shapes of the airbag cushion 120 and its various components, such as the cushion segments 142, that are depicted in FIG. 2 are not necessarily limiting. These shapes may be altered, such as to accommodate differently shaped vehicles. In some embodiments, the airbag cushion 120 is configured to fit within the side window wells of the vehicle 50. The airbag cushion 120 may include a contiguous piece of material manufactured using a one-piece woven technique, in some embodiments, or in other or further embodiments, may be manufactured by cutting and sewing separate pieces of material (e.g., nylon fabric) together. For example, inboard and outboard faces 132, 134 may be formed from separate panels or sheets of material that are joined together. In other embodiments, the inboard and outboard faces 132, 134 may be formed from a unitary piece of material.

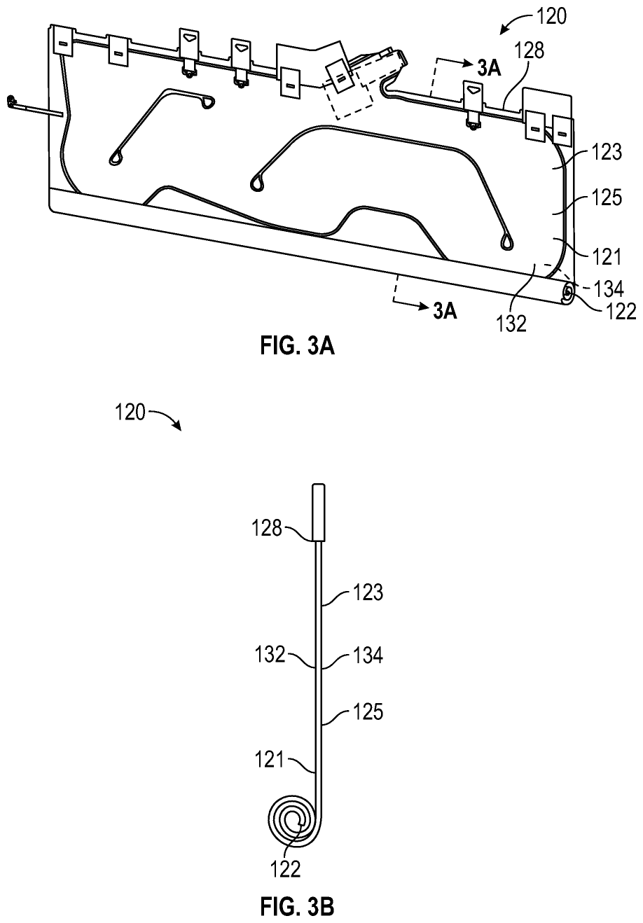

FIGS. 3A-5B are views illustrating the airbag cushion 120 during and upon completion of a packaging process, according to embodiments of the present disclosure. The airbag cushion 120 illustrated in FIGS. 3A-5B is for a passenger side inflatable curtain airbag 100; however, the same packaging process may be used for a driver side inflatable curtain airbag 100 except that the inboard panel 132 and the outboard panel 134 are reversed for the driver side inflatable curtain airbag 100 and the passenger side inflatable curtain airbag 100. As described below, the airbag cushion 120 may be rolled using a bi-directional technique to form a bi-roll configuration of the airbag cushion 120. FIG. 3A is a perspective view and FIG. 3B is a cross-sectional view of the airbag cushion 120 during rolling of the lower portion 121 of the airbag cushion 120, in a first partially packaged state. As illustrated, the lower portion 121 of the airbag cushion 120 can be longitudinally rolled about a longitudinal roll axis in a first rotational direction starting at the lower edge 122 of the airbag cushion 120 toward the upper portion 123 of the airbag cushion 120. In other words, the rolling of the inflatable airbag cushion 120 commences from the lower edge 122 toward the upper edge 128. In the depicted embodiment, the first rotational direction is inward toward the inboard panel 132. In other words, the inboard panel 132 is disposed radially inward and the outboard panel 134 is disposed radially outward as the lower portion 121 is longitudinally rolled. However, the first rotational direction is not limited to be inward toward the inboard panel 132. In some embodiments, the first rotational direction may be inward toward the outboard panel 134.

In certain embodiments, the lower portion 121 may be rolled in the first rotational direction until the rolling reaches the middle portion 125. In other embodiments, the lower portion 121 may be rolled in the first rotational direction until the rolling reaches a vertical midpoint of the airbag cushion 120.

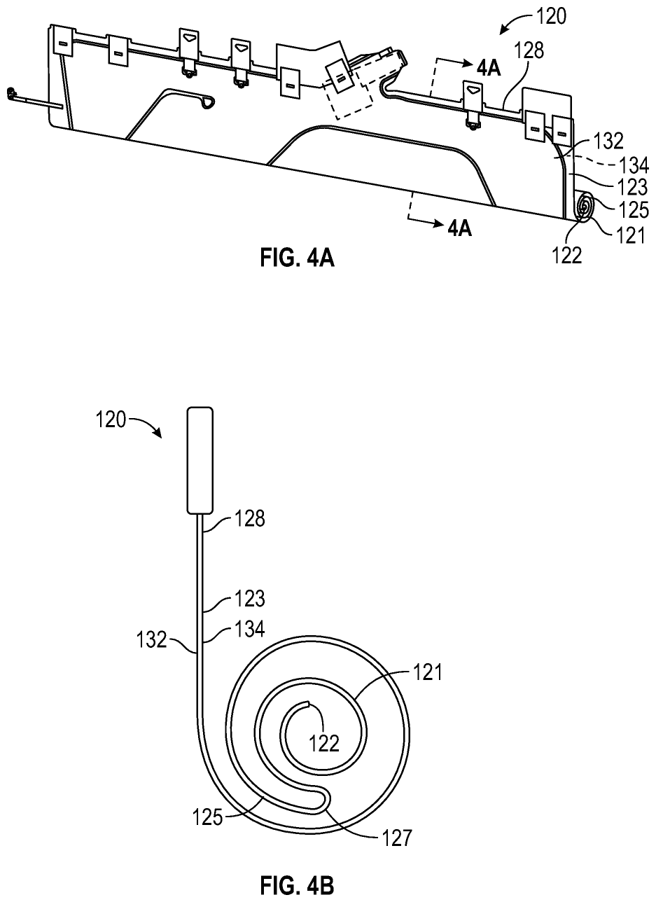

FIG. 4A is a perspective view and FIG. 4B is a cross-sectional view of the airbag cushion 120 during rolling of the upper portion 123 of the airbag cushion 120, in a second partially packaged state. As illustrated, the upper portion 123 can be longitudinally rolled about a longitudinal roll axis in a second rotational direction starting at the middle portion 125 or the vertical midpoint of the airbag cushion 120 and rolling toward the upper edge 128 of the airbag cushion 120. In the depicted embodiment of FIGS. 4A and 4B, the second rotational direction is inward toward the outboard panel 134. In other words, the outboard panel 134 is disposed radially inward and the inboard panel 132 is disposed radially outward as the upper portion 123 is longitudinally rolled. However, the second rotational direction is not limited to be inward toward the outboard panel 134. In some embodiments, the second rotational direction may be inward toward the inboard panel 132.

In some embodiments, a longitudinal fold 127 is disposed in the middle portion 125 between the lower portion 121 and the upper portion 123 as the bi-roll transitions from the first rotational direction to the second rotational direction. In some embodiments, the longitudinal fold 127 is disposed at the vertical midpoint between the lower edge 122 and the upper edge 128. As illustrated, the longitudinal fold 127 is in a direction opposite of the first rotational direction. In some embodiments, the longitudinal fold 127 may be a sharp crease and in other embodiments, the longitudinal fold 127 may be a gentle bend.

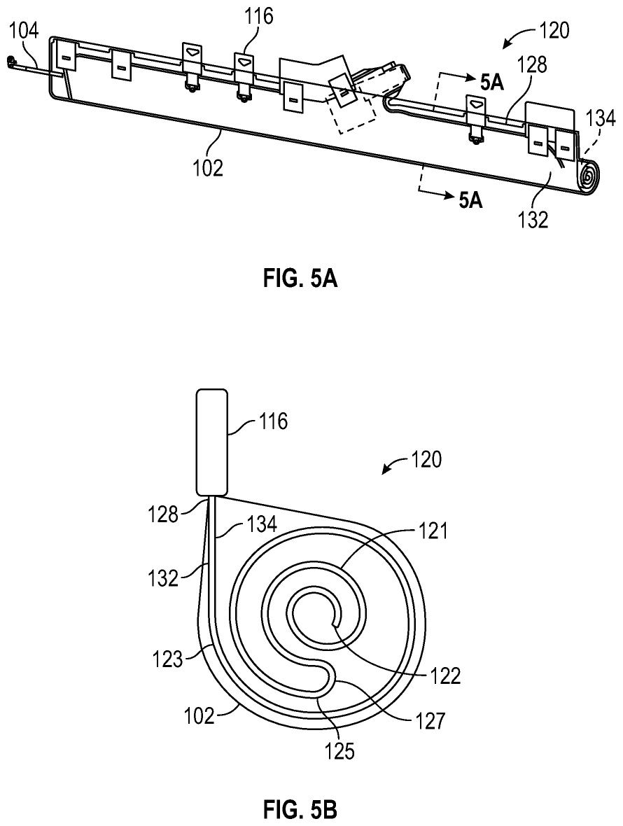

FIGS. 5A and 5B illustrate the airbag cushion 120 in a fully or substantially fully packaged state. As illustrated, the bi-roll of the airbag cushion 120 includes the lower portion 121 longitudinally rolled in the first rotational direction toward the inboard panel 132 and the upper portion 123 longitudinally rolled in the second rotational direction toward the outboard panel 134 such that the lower portion 121 is rolled within the upper portion 123. In some embodiments, the bi-roll of the airbag cushion 120 includes the lower portion 121 longitudinally rolled in the first direction toward the outboard panel 134 and the upper portion 123 longitudinally rolled in the second rotational direction toward the inboard panel 132 such that the lower portion 121 is rolled within the upper portion 123.

When the airbag cushion 120 is deployed from the bi-roll configuration to an inflated configuration, the upper portion 123 can unroll downwardly in a third rotational direction toward the lower portion 121. Initially, the airbag cushion 120 deploys at an outward and downward trajectory. At the longitudinal fold 127 the lower portion 121 can unroll downwardly toward the lower edge 122 in a fourth rotational direction. After the outward and downward trajectory, the airbag cushion 120 deploys at an inward and downward trajectory. Unrolling of the upper portion 123 in the third rotational direction may position the airbag cushion 120 between the occupant's head and the vehicle side window and unrolling of the lower portion 121 in the fourth rotational direction may maintain the airbag cushion 120 within the door trim of the vehicle during deployment and cover the windows on one side of the vehicle.

FIGS. 5A and 5B further illustrates the airbag cushion 120 disposed within the restraint 102 (e.g., sleeve) in the packaged state to restrain the inflatable airbag cushion 120. After the airbag cushion 120 is rolled, the airbag cushion 120 may be inserted into the restraint 102. In certain embodiments, the restraint 102 may be coupled to and/or extend from the mounting tab 116. In certain other embodiments, the restraint 102 may be coupled to and/or extend from a fastening assembly. In the illustrated embodiment, at least a portion of the mounting tab 116 is uncovered such that the mounting tab 116 can be coupled to a mounting bracket to be secured by a fastener to a vehicle, such that the mounting tab 116 may couple the airbag cushion 120 to the vehicle.

Any methods disclosed herein include one or more steps or actions for performing the described method. The method steps and/or actions may be interchanged with one another. In other words, unless a specific order of steps or actions is required for proper operation of the embodiment, the order and/or use of specific steps and/or actions may be modified. For example, a method of packaging an airbag cushion may include one or more of the following steps: obtaining an airbag cushion configured to deploy between an occupant and a vehicle structure, rolling the airbag cushion from a first side of the airbag cushion toward a second side of the airbag cushion in a first rotational direction, and rolling the airbag cushion to the second side in a second rotational direction after rolling the airbag cushion in the first rotational direction, wherein the second rotational direction is opposite the first rotational direction, and wherein the rolling in the first rotational direction and the second rotational direction forms a packaged state for the airbag cushion. Other steps are also contemplated.

Reference throughout this specification to “an embodiment” or “the embodiment” means that a particular feature, structure, or characteristic described in connection with that embodiment is included in at least one embodiment. Thus, the quoted phrases, or variations thereof, as recited throughout this specification are not necessarily all referring to the same embodiment.

Similarly, it should be appreciated that in the above description of embodiments, various features are sometimes grouped together in a single embodiment, figure, or description thereof for the purpose of streamlining the disclosure. This method of disclosure, however, is not to be interpreted as reflecting an intention that any claim require more features than those expressly recited in that claim. Rather, as the following claims reflect, inventive aspects lie in a combination of fewer than all features of any single foregoing disclosed embodiment. Thus, the claims following this Detailed Description are hereby expressly incorporated into this Detailed Description, with each claim standing on its own as a separate embodiment. This disclosure includes all permutations of the independent claims with their dependent claims.

Recitation in the claims of the term “first” with respect to a feature or element does not necessarily imply the existence of a second or additional such feature or element. It will be apparent to those having skill in the art that changes may be made to the details of the above-described embodiments without departing from the underlying principles of the invention. Embodiments of the invention in which an exclusive property or privilege is claimed are defined as follows.

References to approximations are made throughout this specification, such as by use of the term “substantially.” For each such reference, it is to be understood that, in some embodiments, the value, feature, or characteristic may be specified without approximation. For example, where the qualifier “substantially” is used, these terms include within their scope the qualified words in the absence of their qualifier. For example, where the term “substantially airtight” is recited with respect to a feature, it is understood that in further embodiments, the feature can have a precisely airtight configuration.

The terms “a” and “an” can be described as one, but not limited to one. For example, although the disclosure may recite an airbag cushion having “a boundary seam,” the disclosure also contemplates that the airbag cushion can have two or more boundary seams.

Recitation in the claims of the term “first” with respect to a feature or element does not necessarily imply the existence of a second or additional such feature or element.

The claims following this written disclosure are hereby expressly incorporated into the present written disclosure, with each claim standing on its own as a separate embodiment. This disclosure includes all permutations of the independent claims with their dependent claims. Moreover, additional embodiments capable of derivation from the independent and dependent claims that follow are also expressly incorporated into the present written description.

Without further elaboration, it is believed that one skilled in the art can use the preceding description to utilize the invention to its fullest extent. The claims and embodiments disclosed herein are to be construed as merely illustrative and exemplary, and not a limitation of the scope of the present disclosure in any way. It will be apparent to those having ordinary skill in the art, with the aid of the present disclosure, that changes may be made to the details of the above-described embodiments without departing from the underlying principles of the disclosure herein. In other words, various modifications and improvements of the embodiments specifically disclosed in the description above are within the scope of the appended claims. Moreover, the order of the steps or actions of the methods disclosed herein may be changed by those skilled in the art without departing from the scope of the present disclosure. In other words, unless a specific order of steps or actions is required for proper operation of the embodiment, the order or use of specific steps or actions may be modified. The scope of the invention is therefore defined by the following claims and their equivalents.

1. A curtain airbag comprising:
an inflatable airbag cushion in a packaged state that extends along a longitudinal length of a vehicle, the inflatable airbag cushion comprising an outboard side and an inboard side,
wherein the packaged state of the inflatable airbag cushion comprises a bi-roll along a longitudinal direction of the inflatable airbag cushion that commences from a lower edge of the inflatable airbag cushion toward an upper edge,
wherein the bi-roll comprises a first portion rolled in a first rotational direction about a roll axis and a second portion rolled about the roll axis in a second rotational direction, which is opposite the first rotational direction; and
a restraint, enveloping the bi-roll, wherein the restraint extends from one or more mounting tabs for coupling the inflatable cushion to the vehicle.

2. The curtain airbag of claim 1, wherein the bi-roll is formed by rolling a lower portion of the inflatable airbag cushion in the first rotational direction.

3. The curtain airbag of claim 2, wherein the bi-roll is formed by rolling an upper portion of the inflatable airbag cushion in the second rotational direction.

4. The curtain airbag of claim 3, wherein a change of rotational direction from being rolled in the first rotational direction to being rolled in the second rotational direction is at a middle portion of the inflatable airbag cushion.

5. The curtain airbag of claim 3, wherein the changing of the rotational direction between rolling in the first rotational direction to rolling in the second rotational direction is at a vertical midpoint of the inflatable airbag cushion.

6. The curtain airbag of claim 3, wherein the lower portion of the inflatable airbag cushion is an inboard roll where the inflatable airbag cushion is rolled onto the inboard side of the inflatable airbag cushion.

7. The curtain airbag of claim 6, wherein the upper portion of the inflatable airbag cushion is an outboard roll where the inflatable airbag cushion is rolled onto the outboard side of the inflatable airbag cushion.

8. The curtain airbag of claim 7, wherein the changing rotational direction between the inboard roll to the outboard roll is at a middle portion of the inflatable airbag cushion.

9. The curtain airbag of claim 7, wherein the changing rotational direction between the inboard roll to the outboard roll is at a vertical midpoint of the inflatable airbag cushion.

10. (canceled)

11. (canceled)

12. The curtain airbag of claim 1, further comprising an inflator partially disposed within the inflatable airbag cushion and configured to expel an inflation gas to inflate the inflatable airbag cushion upon deployment.

13. The curtain airbag of claim 1, wherein the bi-roll comprises a fold in a direction that is opposite the first rotational direction.

14. A method comprising:
obtaining an airbag cushion configured to deploy between an occupant and a vehicle structure;
rolling the airbag cushion from a first side of the airbag cushion toward a second side of the airbag cushion in a first rotational direction; and
rolling the airbag cushion from the second side toward the first side in a second rotational direction after rolling the airbag cushion in the first rotational direction,
wherein the second rotational direction is opposite the first rotational direction,
wherein the rolling in the first rotational direction and the second rotational direction forms a packaged state for the airbag cushion; and
enveloping the airbag cushion in the packaged state in a restraint, wherein the restraint extends from one or more mounting tabs for coupling the inflatable cushion to a vehicle.

15. The method of claim 14, wherein the first rotational direction is an inboard roll in that the airbag cushion is rolled onto an inboard side of the airbag cushion.

16. The method of claim 15, wherein the second rotational direction is an outboard roll in that the airbag cushion is rolled onto an outboard side of the airbag cushion.

17. The method of claim 14, wherein changing rolling in the first direction to the second direction is at a middle portion of the airbag cushion.

18. The method of claim 14, wherein changing rolling in the first rotational direction to the second rotational direction is at a vertical midpoint of the airbag cushion.

19. The method of claim 14, wherein the restraint maintains the airbag cushion in the packaged state.

20. The method of claim 14, wherein the airbag cushion is a curtain airbag cushion and is positioned in a longitudinal direction of the vehicle.
